(19) United States
(12) Patent Application Publication
(10) Pub. No.: US 2015/0042519 A1
(43) Pub. Date: Feb. 12, 2015

(54) HANDHELD ELECTRONIC DEVICE

(71) Applicants: Li-Wei Cheng, Taipei City (TW); Hung-Sung Pan, Taipei City (TW)

(72) Inventors: Li-Wei Cheng, Taipei City (TW); Hung-Sung Pan, Taipei City (TW)

(73) Assignee: COMPAL ELECTRONICS, INC., Taipei City (TW)

(21) Appl. No.: 14/454,723

(22) Filed: Aug. 8, 2014

(30) Foreign Application Priority Data
Aug. 8, 2013 (TW) 102128525

(51) Int. Cl. H01Q 1/24

(52) U.S. Cl. CPC H01Q 1/243
USPC 343/702

(57) ABSTRACT

A handheld electronic device includes a main body, an antenna, a gravity sensor and a control circuit. The main body has an operation surface. The operation surface has a first side and a second side opposite to each other. The antenna is disposed in the main body and located near the first side. The gravity sensor is disposed in the main body and capable of sensing a tilted state of the main body relative to a gravity direction. The control circuit is electrically connected to the antenna and the gravity sensor. When a position of the first side is higher than a position of the second side and an included angle between the operation surface and the gravity direction is between 0 degree and a predetermined value, the control circuit increases power of the antenna.

### CROSS-REFERENCE TO RELATED APPLICATION

This application claims the priority benefit of Taiwan application serial no. 102128525, filed on Aug. 8, 2013. The entirety of the above-mentioned patent application is hereby incorporated by reference herein and made a part of this specification.

### BACKGROUND OF THE INVENTION

1. Field of the Invention

The invention relates to a handheld electronic device, and more particularly, to a handheld electronic device having an antenna.

2. Description of Related Art

With advancement of information technology at present, it becomes easier and easier to obtain desired information from electronic devices in daily life. By virtue of an improvement of the state of the art, various types of handheld electronic devices are developed to be lighter and slimmer. Being advantaged in portability, handheld electronic devices are popular and broadly used in daily life. Take tablet computers and smartphones as examples, they are usually disposed with an antenna to provide wireless connection.

A specific absorption rate (SAR) test is a type of a test for measuring effects of electromagnetic wave generated by an electronic device on a human body. When an antenna of an electronic device is too close to a human body, electromagnetic wave generated by the antenna increases a SAR value, and sometimes even exceeds the specification. Handheld electronic devices such as tablet computers and smartphones having antennas must be tested with SAR, so as to ensure that effects of electronic wave generated by the aforesaid devices on the human body are within a safety range.

### SUMMARY OF THE INVENTION

The invention provides a handheld electronic device which can reduce effects of electromagnetic wave generated by an antenna on a human body.

The invention provides a handheld electronic device including a main body, an antenna, a gravity sensor (G sensor) and a control circuit. The main body has an operation surface. The operation surface has a first side and a second side opposite to each other. The antenna is disposed in the main body and located near the first side. The gravity sensor is disposed in the main body and capable for sensing a tilted state of the main body relative to a gravity direction. The control circuit is electrically connected to the antenna and the gravity sensor. When the control circuit senses that a position of the first side is higher than a position of the second side through the gravity sensor, and an included angle between the operation surface and the gravity direction is between 0 degree and a predetermined value, the control circuit increases power of the antenna.

In light of the above, the handheld electronic device of the invention can sense a tilted state of the main body relative to a gravity direction through the gravity sensor, and change power of the antenna based on the tilted state of the main body relative to the gravity direction, such that effects of electromagnetic wave generated by the antenna on the human body are minimized.

Several exemplary embodiments accompanied with figures are described in details below to further describe the invention in details.

### BRIEF DESCRIPTION OF THE DRAWINGS

FIG. 1 is a three dimensional view of a handheld electronic device according to an embodiment of the invention.

FIG. 2 is a circuit block diagram illustrating the handheld electronic device of FIG. 1.

FIG. 3 is a schematic diagram illustrating the handheld electronic device of FIG. 1 in an upright state.

FIG. 4 is a schematic diagram illustrating the handheld electronic device of FIG. 1 in a tilted state.

FIG. 5A is a schematic diagram illustrating the handheld electronic device of FIG. 1 in a transverse state.

FIG. 5B is a schematic diagram illustrating the handheld electronic device of FIG. 1 in a horizontal state.

FIG. 5C is a schematic diagram illustrating the handheld electronic device of FIG. 1 in another horizontal state.

FIG. 6 is a three dimensional view of a handheld electronic device according to another embodiment of the invention.

FIG. 7 is a circuit block diagram illustrating the handheld electronic device of FIG. 6.

### DESCRIPTION OF EMBODIMENTS

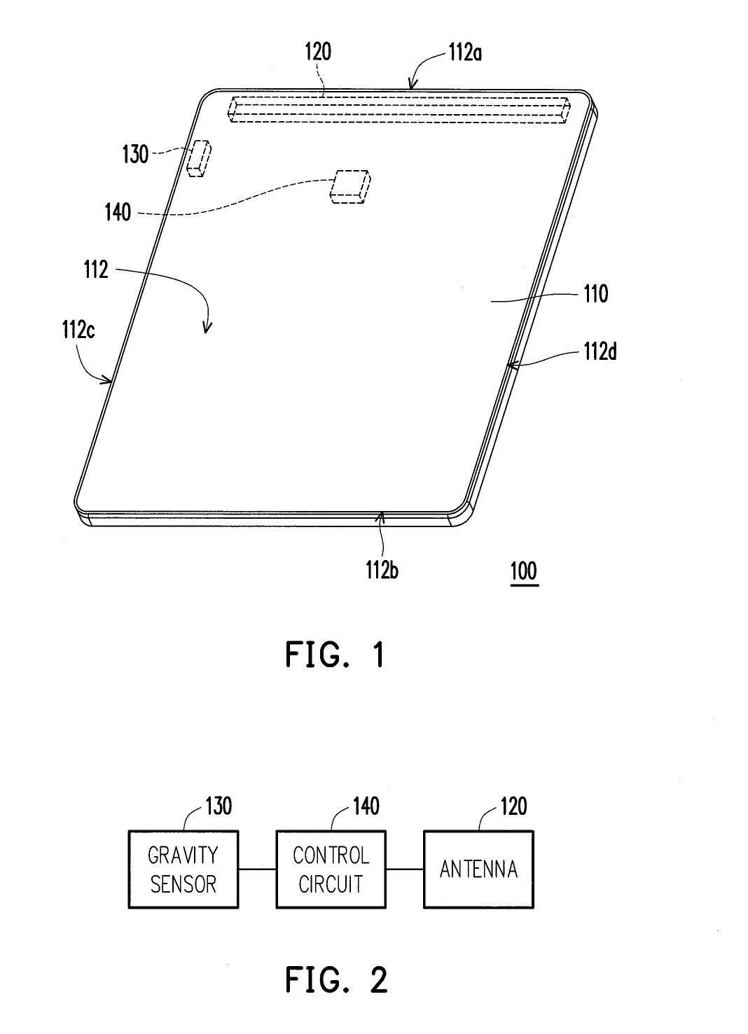

FIG. 1 is a three dimensional view of a handheld electronic device according to an embodiment of the invention. FIG. 2 is a circuit block diagram illustrating the handheld electronic device of FIG. 1. Referring to FIG. 1 and FIG. 2, a handheld electronic device 100 of the present embodiment, for example, is a tablet computer or a smartphone. The handheld electronic device 100 includes a main body 110, an antenna 120, a gravity sensor 130 and a control circuit 140. The main body 110 has an operation surface 112, wherein the operation surface 112 is one surface having an image display area of the main body 110. The operation surface 112 has a first side 112a and a second side 112b opposite to each other, wherein the first side 112a and the second side 112b are two sides of the operation surface 112 and are parallel to each other. The antenna 120 is disposed in the main body 110 and located near the first side 112a. The gravity sensor 130 and the control circuit 140 are disposed in the main body 110, and the control circuit 140 electrically connects to the antenna 120 and the gravity sensor 130 as shown in FIG. 2. The gravity sensor 130 is capable of sensing a tilted state of the main body 110 relative to a gravity direction, and changes power of the antenna 120 through the control circuit 140 based on the tilted state of the main body 110 relative to the gravity direction.

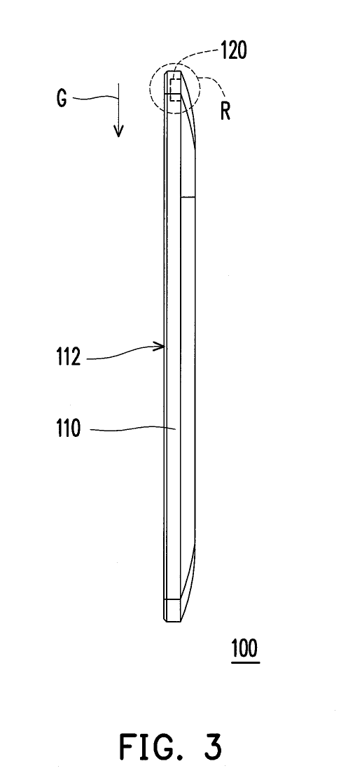

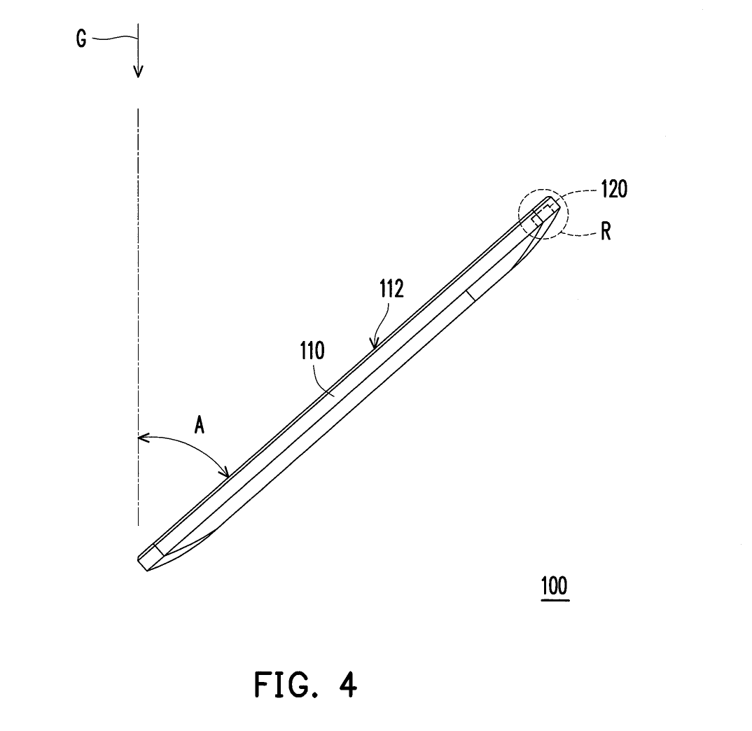

FIG. 3 is a schematic diagram illustrating the handheld electronic device of FIG. 1 in an upright state. FIG. 4 is a schematic diagram illustrating the handheld electronic device of FIG. 1 in an upright state. Referring to FIG. 3 and FIG. 4, specifically, when a position of the first side 112a is higher than a position of the second side 112b, a value of an included angle A between the operation surface 112 and a gravity direction G is smaller than a predetermined value, and the predetermined value falls between 0 degree (as shown in FIG. 3) and 60 degrees (as shown in FIG. 4), a user usually would not hold a region R at which the antenna 120 of the handheld electronic device 100 is located, wherein the predetermined value falls between 40 degrees and 60 degrees, and preferably at 45 degrees. However, the aforesaid is not intended to limit the scope of the invention.

Therefore, when the handheld electronic device 100 is tilted within the tilted range between FIG. 3 and FIG. 4 for the antenna 120 staying farther from the human body, the control circuit 140 senses a tilted state of the handheld electronic device 100 right at that moment through the gravity sensor 130, and adjusts power of the antenna 120, such that the antenna 120 is the antenna having higher power for an electronic device to have a better performance of signal transmission.

In addition, when an included angle A of the handheld electronic device 100 is not within the tilted range for the antenna 120 to stay closer to the human body, the control circuit 140 senses a tilted state of the handheld electronic device 100 right at that moment through the gravity sensor 130, and adjusts power of the antenna 120 in a lower power, such that effects of electromagnetic wave generated by the antenna 120 on the human body are minimized.

In the present embodiment, the predetermined value of the included angle A, for example, is 45 degrees. However, the invention is not limited herein. In other embodiments, the predetermined value of the included angle A can be deemed as other appropriate degrees based on the needs.

Furthermore, when the control circuit 140 adjusts the antenna 120 for having lower power based on a sensed result of the gravity sensor 130, the antenna 120 has a first power. When the control circuit 140 adjusts the antenna 120 for having higher power based on the sensed result of the gravity sensor 130, the antenna 120 has a second power. The first power, for example, is 5% to 80% of the second power.

In other words, when the handheld electronic device 100 is within the tilted range between FIG. 3 and FIG. 4 for the antenna 120 to be farther away from the human body, power of the antenna 120 is increased to a maximum. When the handheld electronic device 110 is not within the tilted range for the antenna 120 to be closer to the human body, power of the antenna 120 is decreased to 5% to 80% of the maximum. However, the invention does not limit power reduction range of the antenna 120. In other embodiments, power of the antenna 120 can also be reduced to other suitable ranges.

As shown in FIG. 1, an outer contour of the operation surface 112 of the present embodiment substantially is a rectangle. The first side 112a and the second side 112b are two short sides of the rectangle, while a third side 112c and a fourth side 112d are two long sides of the rectangle. The antenna 120, for example, is a strip structure, and extends along a direction parallel to the first side 112a. Thus, when a user holds the second side 112b, the third side 112c or the fourth side 112d, the antenna 120 is not too close to the user. However, the invention does not limit shapes of the antenna 120. In other embodiments, the antenna 120 can have other suitable shapes.

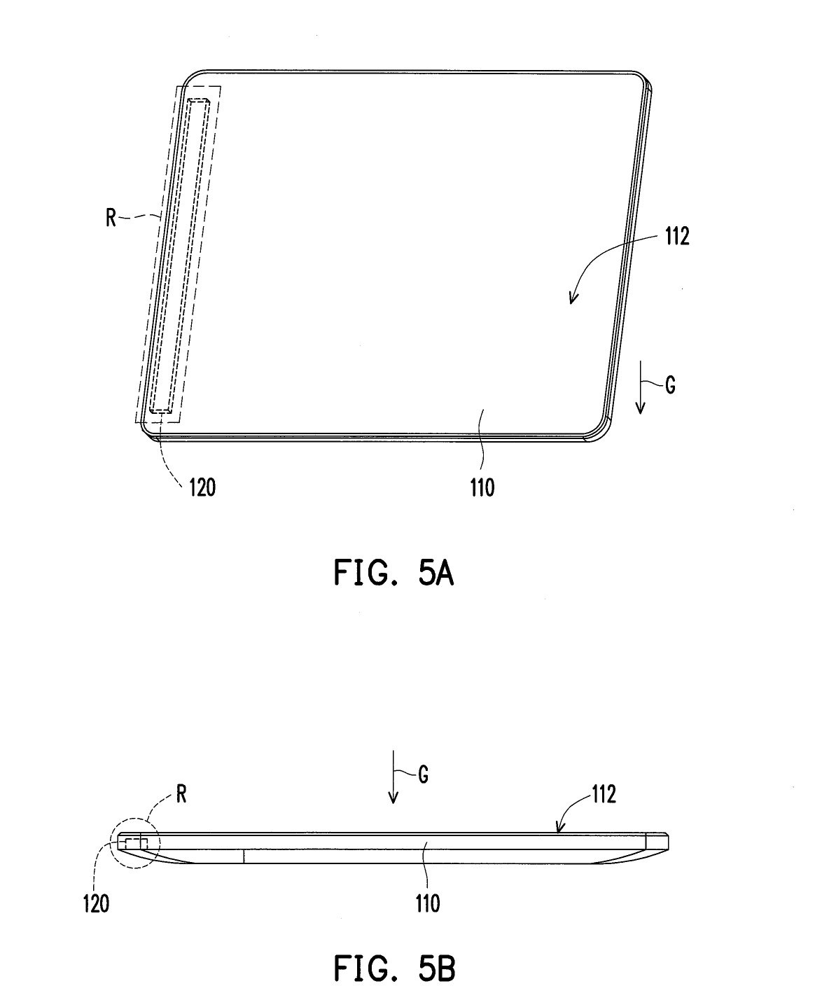

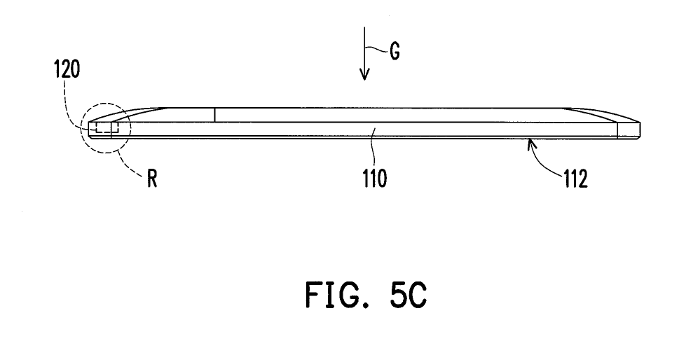

The followings are examples explaining the handheld electronic device 100 in tilted states not within the tilted range between FIG. 3 and FIG. 4 by referring to FIG. 5A to FIG. 5C.

FIG. 5A is a schematic diagram illustrating the handheld electronic device in a horizontal state of FIG. 1 in a transverse state. Referring to FIG. 5A, when the handheld electronic device 100 is in a transverse state, rather than in the tilted range between FIG. 3 and FIG. 4, the user may hold the region R at which the antenna 120 of the handheld electronic device 100 is located. Therefore, the control circuit 140 reduces power of the antenna 120, such that effects of electromagnetic wave generated by the antenna 120 on the human body are minimized.

FIG. 5B is a schematic diagram illustrating the handheld electronic device of FIG. 1 in a horizontal state. Referring to FIG. 5B, when the handheld electronic device 100 is in a horizontally state and the operation surface 112 faces upwards, rather than in the tilted range between FIG. 3 and FIG. 4, the user may hold the region R at which the antenna 120 of the handheld electronic device 100 is located. Therefore, the control circuit 140 reduces power of the antenna 120 according to the sensed result of the gravity sensor 130, such that effects of electromagnetic wave generated by the antenna 120 on the human body are minimized.

FIG. 5C is a schematic diagram illustrating the handheld electronic device of FIG. 1 in another horizontal state. Referring to FIG. 5B, when the handheld electronic device 100 is in another horizontally state and the operation surface 112 faces downwards, rather than in the tilted range between FIG. 3 and FIG. 4, the user may hold the region R at which the antenna 120 of the handheld electronic device 100 is located. Therefore, the control circuit 140 reduces power of the antenna 120 according to the sensed result of the gravity sensor 130, such that effects of electromagnetic wave generated by the antenna 120 on the human body are minimized.

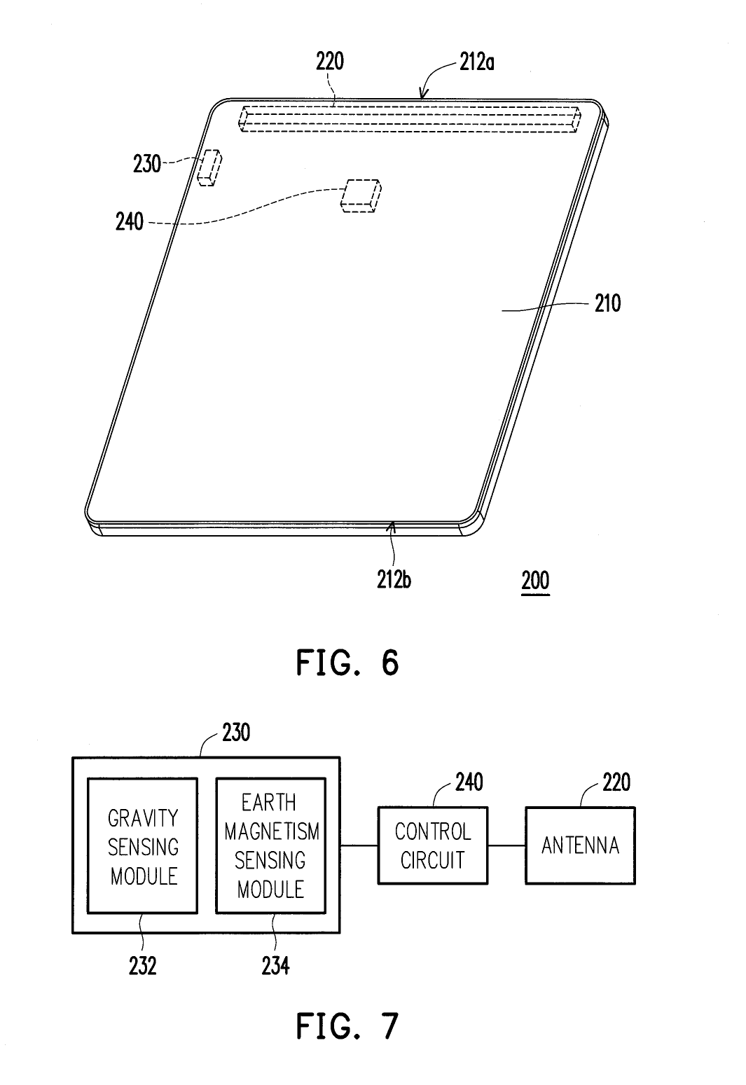

In the embodiment of FIG. 1, the gravity sensor 130, for example, is a capacitive gravity sensor, and is capable of determining whether the first side 112a is higher than the second side 112b, and is capable of sensing a tilted angle of the main body 110 of the handheld electronic device 100. However, the invention does not limit types of the gravity sensor 130. The following examples describe gravity sensors in other types with reference to FIG. 6 and FIG. 7.

FIG. 6 is a three dimensional view of a handheld electronic device according to another embodiment of the invention. FIG. 7 is a circuit block diagram illustrating the handheld electronic device of FIG. 6. Referring to FIG. 6 and FIG. 7, in a handheld electronic device 200 of the present embodiment, a gravity sensor 230, for example, is a non-capacitive gravity sensor, and is electrically connected to the antenna 220 and the control circuit 240. The gravity sensor 230 includes a gravity sensing module 232 and an earth magnetism sensing module 234, and is capable for determining whether a first side 212a is higher than a second side 212b through the gravity sensing module 232, and is capable for sensing a tilted angle of a main body 210 of the handheld electronic device 200 through the earth magnetism sensing module 234.

In summary, the handheld electronic device of the invention can sense a tilted state of a main body relative to a gravity direction through a gravity sensor, and change power of an antenna based on the tilted state of the main body relative to the gravity direction, such that effects of electromagnetic wave generated by the antenna on the human body are minimized. Accordingly, when a handheld electronic device is within a tilted range and thereby an antenna is farther away from a human body, the handheld electronic device can adjust the antenna for higher power. Furthermore, when the handheld electronic device is outside a tilted range and thereby an antenna is closer the human body, the handheld electronic device can adjust the antenna for lower power.

It will be apparent to those skilled in the art that various modifications and variations can be made to the structure of the disclosed embodiments without departing from the scope or spirit of the invention. In view of the foregoing, it is intended that the disclosure cover modifications and variations of this specification provided fall within the scope of the following claims and their equivalents.

What is claimed is:

1. A handheld electronic device, comprising:
a main body having an operation surface, wherein the operation surface has a first side and a second side opposite to each other;
an antenna disposed in the main body and located near the first side;
a gravity sensor disposed in the main body, and capable of sensing a tilted state of the main body relative to a gravity direction; and
a control circuit electrically connected to the antenna and the gravity sensor, wherein, when the control circuit senses that a position of the first side is higher than a position of the second side through the gravity sensor, and an included angle between the operation surface and the gravity direction is smaller than a predetermined value, the control circuit increases power of the antenna.

2. The handheld electronic device as recited in claim 1, wherein the predetermined value is 45 degrees.

3. The handheld electronic device as recited in claim 1, wherein the gravity sensor is a capacitive gravity sensor.

4. The handheld electronic device as recited in claim 1, wherein the gravity sensor includes a gravity sensing module and an earth magnetism sensing module.

5. The handheld electronic device as recited in claim 1, wherein, before the control circuit increases power of the antenna according to a sensed result of the gravity sensor, the antenna has a first power, and after the control circuit increases power of the antenna according to the sensed result of the gravity sensor, the antenna has a second power, and the first power is 5% to 80% of the second power.

6. The handheld electronic device as recited in claim 1, wherein the handheld electronic device is a tablet computer or a smart phone.

7. The handheld electronic device as claimed in claim 1, wherein the antenna is a strip structure and extends along a direction parallel to the first side.

8. The handheld electronic device as recited in claim 1, wherein an outer contour of the operation surface is substantially a rectangle, the operation surface further comprises a third side and a fourth side, the first side and the second side are two short sides of the rectangle, and the third side and the fourth side are two long sides of the rectangle.
